(19) United States
(12) Patent Application Publication
(10) Pub. No.: US 2008/0052096 A1
(43) Pub. Date: Feb. 28, 2008

(54) Method of merchandising complementary medallions

(76) Inventor: Robert W. Lackey, Hickory, NC (US)

Correspondence Address: Charles L. Schwab;Nexsen Pruet, LLC, Post Office Box 10107, Greenville, SC, 29603, US

(21) Appl. No.: 11/509,342

(22) Filed: Aug. 24, 2006

(51) Int. Cl. G06Q 10/00; G06Q 30/00

(52) U.S. Cl. 705/1

(57) ABSTRACT

A method of marketing complementary medallions optimizing customer selection and minimizing merchant inventory, stocking and display space requirements.

### RELATED APPLICATIONS

The herein disclosed subject matter is closely related to that of the inventor's co-pending U.S. patent application No. ______ filed ______ for a Medallion which is incorporated herein by reference.

### BACKGROUND OF THE INVENTION

Ceiling medallions in the form of decorative disks are used to accent or enhance the appearance of a ceiling fixture, such as a light fixture or ceiling fan. The medallions are decorative and a variety of surface ornamentations are used to provide the desired aesthetic effect. Homeowners and decorators are using a great many variations in room décor and there are many differences in personal preferences concerning interior decoration; thus giving rise to a need for a wide variety of ceiling medallions. Merchandising a multitude of medallions requires a relatively large inventory and expansive storage and display space.

### BRIEF DESCRIPTION OF THE INVENTION

Complementary medallion components are provided which produce decorative effects in concert different than those produced separately. A relatively few complementary components are capable of producing a relatively large number of distinctive medallion designs by mixing and matching. The components can be sold and used individually or in sets; thereby not only giving the customer a wide choice of medallion designs but also reducing the vendor's inventory and space required for stocking and retail display.

### BRIEF DESCRIPTION OF THE DRAWINGS

Mix and match medallions are shown in the drawings, in which:

FIG. 1 is a front view of a square shaped medallion;

FIG. 2 is a front view of a ring shaped medallion;

FIG. 3 is a front view of a relatively small disc shaped medallion;

FIG. 4 is a front view of a composite medallion formed by combining the medallions of FIGS. 1 and 2;

FIG. 5 is a front view of a composite medallion formed by combining the medallions of FIGS. 1 and 3;

FIG. 6 is a front view of a composite medallion formed by combining the medallions of FIGS. 2 and 3;

FIG. 7 is a front view of a composite medallion formed by combining the medallions of FIGS. 1, 2 and 3;

FIG. 8 shows the medallion of FIG. 1 in a retail display package;

FIG. 9 shows the medallion of FIG. 2 in a retail display package;

FIG. 10 shows the medallion of FIG. 3 in a retail display package;

FIG. 11 shows the medallion of FIG. 7 in a retail display package;

FIG. 12 is a front view of a star burst shaped medallion;

FIG. 13 is a front view of a star burst shaped medallion which is smaller than the medallion of FIG. 8;

FIG. 14 is a front view of a composite medallion formed by combining the medallions of FIGS. 8 and 9;

FIG. 15 is a partial rear view of the medallion of FIG. 9 showing part of a protective coversheet being removed to expose adhesive on the back side of the medallion.

### DETAILED DESCRIPTION OF THE INVENTION

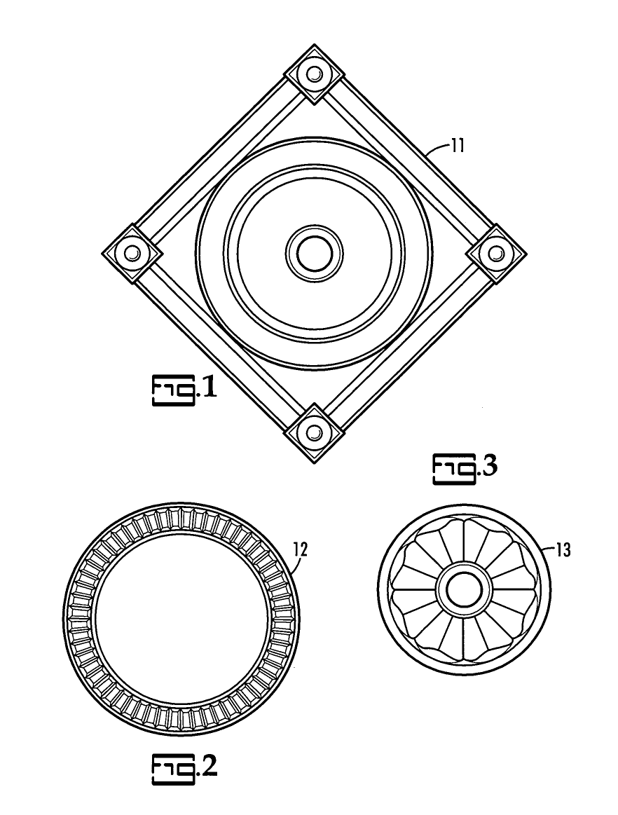

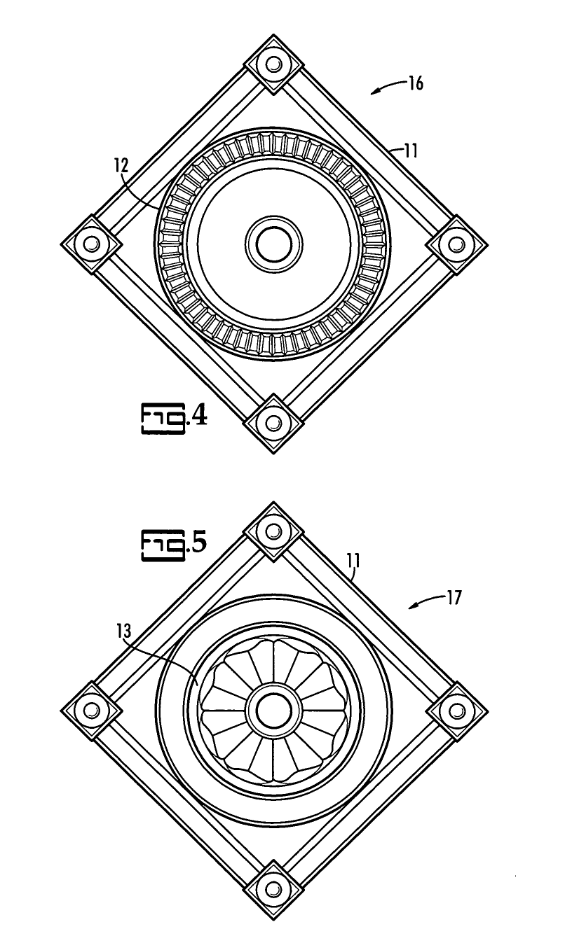

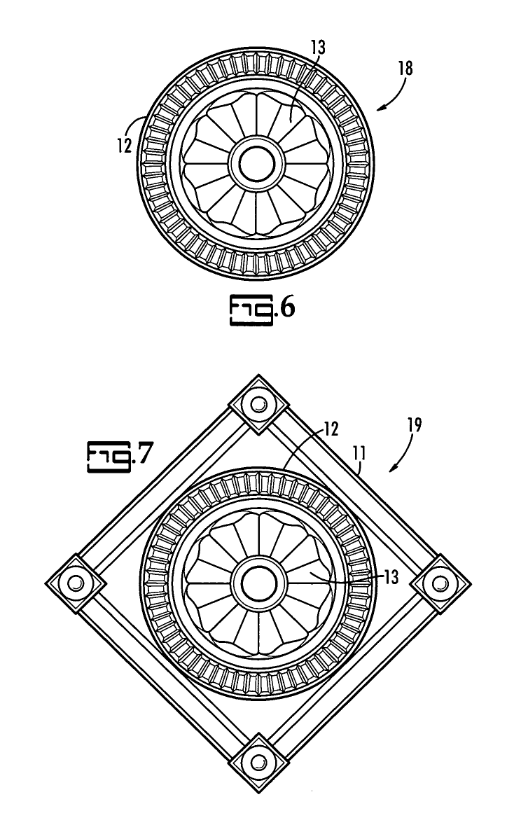

FIGS. 1, 2 and 3 illustrate three complementary mix and match medallions 11, 12 and 13 which may be formed from various materials in a variety of ways. For instance they may be molded using foam type plastic with a surface suitable for application of spray paint or other decorative or protective finish or cover coat. FIG. 4 shows a composite medallion 16 formed by combining the ring shaped medallion 12 and the larger medallion 11. FIG. 5 shows a composite medallion 17 formed by combining the medallion of FIG. 1 and the disc shaped medallion of FIG. 3. FIG. 6 shows a composite medallion 18 formed by combining the medallions of FIGS. 2 and 3. FIG. 7 shows a composite medallion 19 formed by combining the medallions of FIGS. 1, 2 and 3.

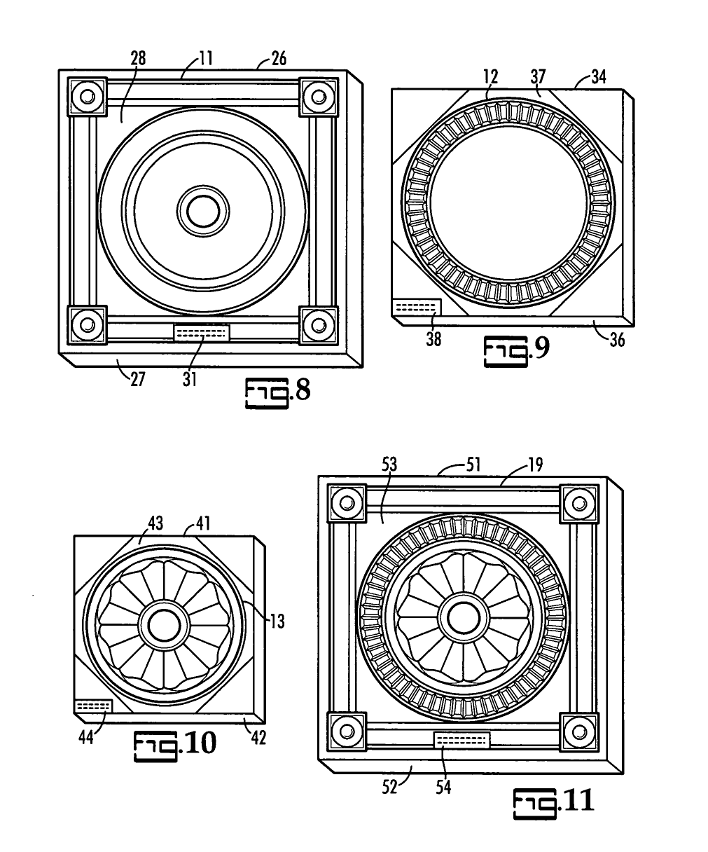

FIG. 8 shows the medallion 11 of FIG. 1 in a retail display package 26 including a cardboard box 27 with a clear see through top or cover 28 to which a price and identification label 31 is attached. In a similar manner FIG. 9 shows the medallion ring 12 in a retail display or merchandising package 34 which has a cardboard box 36 with a transparent cover 37 together with a price and identification label 38. FIG. 10 shows the disc shaped medallion 13 in a display package 41 which includes a box 42, a transparent top 43 and a price and identification label 44. The multi-component medallion 19 is shown in FIG. 11 packaged in a container 51 which includes a cardboard box 52 with a plastic transparent cover 53 and a price and product identification label 54. The retail merchant needs only to stock four items in order to afford the customer seven medallion choices. The rear of the package may carry pictorials showing how the components can be used singularly or in various combinations.

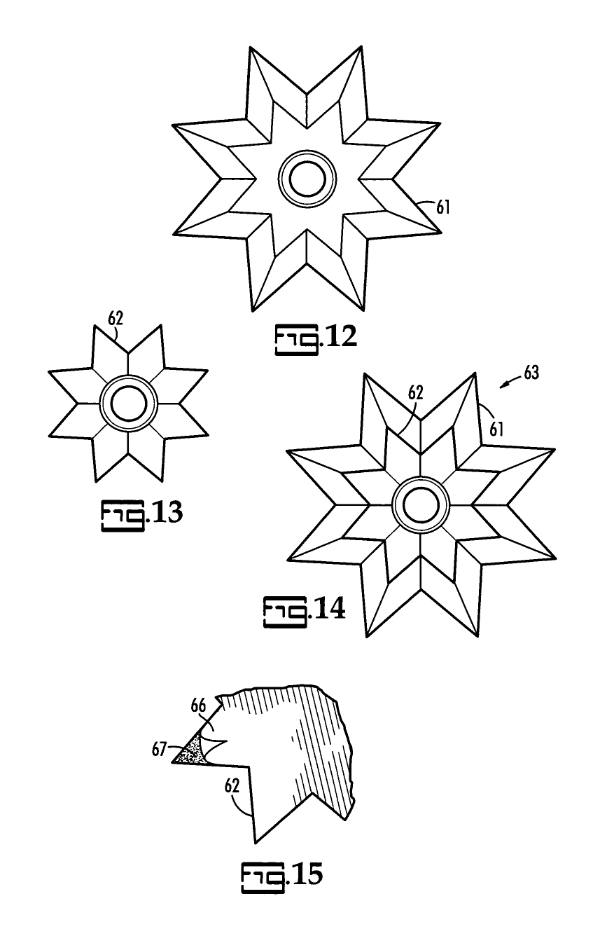

FIG. 12 and 13 show complementary star shaped medallions 61 and 62 which can be used separately or united as shown in FIG. 14 to form a composite medallion 63. FIGS. 1-14 show only a few of the medallion styles and ornamentations that are possible with the herein disclosed method of merchandising medallions. The component medallions can be secured to one another in various ways. One method is illustrated in FIG. 15 which shows a thin protective sheet of plastic or other backing 66 being removed from the back side of the star like medallion 62 thereby exposing a protected adhesive 67 by which it can be secured to wall, ceiling or other medallions . . . The complementary medallions may be jointed by snap lock connections. One such snap lock connection being shown in my co pending U.S. application, Ser. No. ______ filed August ______, 2006.

The herein disclosed method of merchandising medallions gives the customer a choice of a medallion design without requiring purchase of a package containing all the complementary components. For the customer who desires a medallion configuration using all the complementary medallions, he or she can simply buy the single package containing all the components, which can logically be priced below the sum of the prices of the individually packaged components. Those desiring to create a composite medallion using fewer medallions simply buy the required individually packaged medallions.

What is claimed is:

1. A method of merchandising medallions, comprising the step of:
producing a plurality of complementary medallions suitable for use individually or in selected composites,
packaging a set of said plurality of medallions in a single merchandising package, and
packaging each of said plurality of medallions in individual merchandising packages.

2. The method of claim 1 wherein said plurality of medallions is at least three.

3. The method of claim 2 including the step of providing said medallions with mechanism facilitating their being interconnected to form said selected composites.

4. The method of claim 1 including the step of providing said medallions with mechanism facilitating their being interconnected to form said selected composites.
